(19) United States
(12) Patent Application Publication
(10) Pub. No.: US 2013/0253872 A1
(43) Pub. Date: Sep. 26, 2013

(54) FLOW METER CALIBRATION SYSTEM

(71) Applicants: Anthony Curtis, Alresford (GB); Soovo Sen, Houston, TX (US); Prakash Mistry, Sugar Land, TX (US); Hai Wang, Sugar Land, TX (US); Michael George Brosseau, Stafford, TX (US)

(72) Inventors: Anthony Curtis, Alresford (GB); Soovo Sen, Houston, TX (US); Prakash Mistry, Sugar Land, TX (US); Hai Wang, Sugar Land, TX (US); Michael George Brosseau, Stafford, TX (US)

(73) Assignee: THERMO FISHER SCIENTIFIC INC., Sugar Land, TX (US)

(21) Appl. No.: 13/425,023

(22) Filed: Mar. 20, 2012

(51) Int. Cl. G01F 25/00; G06F 19/00

(52) U.S. Cl. 702/100; 73/1.16; 73/1.35

(57) ABSTRACT

A method to calibrate a flow meter includes passing a predetermined volume of fluid through a flow meter for calibration and determining a time duration of calibration from a start time to a stop time. One or more characteristics of the flow rate of the fluid is measured with the flow meter during the time duration and a plurality of time stamped measurements based on the one or more measured flow rate characteristics are generated. The flow meter is then calibrated based on the start time, the stop time, and the plurality of time stamped measurements.

### BACKGROUND

1. Field of the Disclosure

This invention relates to a calibration system for a flow meter.

2. Description of the Related Art

Small volume provers (SVPs) are widely used in the oil and gas industry as field standards to calibrate, i.e., prove, flow meters. An SVP is a fluid containing device having an internal bore cylinder having a precisely calibrated volume. An SVP is further equipped with an internal displacer, such as a piston or sphere, that moves within the internal bore cylinder to displace or force a precisely calibrated volume of fluid through a flow meter under calibration. Furthermore, detectors such as optical sensors or electronic switches may be positioned at two positions along the length of the SVP (thus, defining the length of the calibrated internal bore) to detect when the displacer passes either end of the calibrated internal bore. Typical small volume provers used in the oil and gas industry may have internal bore cylinders as small as 1 bbl that allow for short proving runs (about 1 second). Furthermore, the relatively compact size of SVPs allows for their portability, e.g., by way of truck or trailer, facilitating their widespread use at remote field locations.

FIGS. 1A-C illustrate the basic concept of a small volume proving operation. A flow meter 101 is connected to prover 103. Before the proving operation, the internal bores of both flow meter 101 and prover 103 may be filled with fluid 105, as shown in FIG. 1A. Further, the internal bore of prover 103 may contain a calibrated volume that includes a fraction 107 of the fluid 105. The fraction 107 initially resides between detectors 109 and 111. During a proving operation, displacer 113, moves laterally along the internal bore of the prover, thereby inducing fluid flow through both the prover 103 and the flow meter 101, as shown in the progression of FIGS. 1A-C. As shown in FIG. 1A, when displacer 113 encounters the leading edge of the prover's calibrated internal bore (i.e., the displacer passes detector 109), the detector 109 outputs a first indication, e.g., a first voltage pulse, to indicate the start time tₛₜₐᵣₜ of the movement of the calibrated volume of fluid through the system. At a later time, as shown in FIG. 1C, when the displacer encounters the trailing edge of the calibrated internal bore (i.e., passes detector 111), detector 111 outputs a second indication, e.g., a second voltage pulse to indicate the time of completion t_{end} of the passage of the calibrated volume. Accordingly, during a proving run that commenced at tₛₜₐᵣₜ and ended at t_{end}, a calibrated volume of fluid 119 (shown in FIG. 1C), which is identical in volume to the fraction 107, has moved through the flow meter 101, e.g., past reference point 115. As is known the art, many different types of provers are available. For example, ball provers may employ a spherical ball as a displacer and accordingly, the start and end indications made by detectors 109 and 111 are known as sphere detects. As used herein, the term sphere detect is understood to encompass any prover indication and is not limited to provers that merely employ spheres as displacers.

Historically, SVPs have been used to calibrate turbine meters. A turbine meter is an integrating flow device that generates pulses as it rotates due to the flow of the fluid in the pipe. For example, the certain inline flow turbine meters include a compact body or spool piece that contains a rotating impeller, or rotor. The assembly functions very much like a windmill in that the rotational speed is directly proportional to the flow rate. The rotor, which may be manufactured from magnetic stainless steel, generates a pulsed output as the blades rotate through the magnetic flux of a magnet that is contained in the pickup assembly. Accordingly, as shown in FIG. 1, the flow meter may output a certain number of pulses 117, each representing a portion of the fluid that moved through the meter during the time elapsed between tₛₜₐᵣₜ and tₛₜₒₚ. A flow meter measurement factor, or K-factor, may then be calculated by counting the number of pulses between tₛₜₐᵣₜ and tₛₜₒₚ and dividing this number of pulses by the calibrated volume of the prover.

FIG. 2A shows an example of pulses generated by a turbine meter during a proving run, i.e., between tₛₜₐᵣₜ and tₛₜₒₚ. Due to the pulse generating mechanism within turbine meters, the pulses are generated immediately, with no inherent delays, and, thus, an accurate measurement of the total volume may be achieved using an SVP. The pulses generated by a turbine meter between tₛₜₐᵣₜ and tₛₜₒₚ are counted by a pulse counter, also known as a totalizer, in order to generate a highly accurate meter K-factor, which may be given in pulses per unit volume. Alternatively, using the flow meter's predefined K-factor, a meter factor may be derived, defined as the ratio of the actual prover volume to the measured volume during the proving run using the meter. This meter factor may then be applied as a scale factor to future measurements using the meter to ensure accurate flow measurements.

Alternative types of flow meters are also used in the oil and gas industry. These meters may not necessarily employ a direct method of measuring the flow through the meter or a direct way to produce output pulses from the meter, e g., many meters lack the spinning rotor of the standard turbine flow meter. Rather, non-turbine flow meters may measure a flow rate characteristic of the fluid which may later be converted to a flow rate. For example, an ultrasonic flow meter (UFM) uses a transducer to transmit an ultrasonic signal into a fluid that is received by a second transducer. The fluid carrying the ultrasonic signal alters the signal's frequency (Doppler effect) and transit-time (velocity superposition), such that a measure of one of these two flow rate characteristics may be used to determine a fluid flow rate. Based on these principles, two major ultrasonic flow measurement technologies exist: Doppler and transit-time. Transit-time meters are employed in the oil and gas industry for clean fluid applications.

Transit time UFMs may further include measurements along multiple paths. The multipath measurements allow for the computation of a fluid flow profile across the pipe. The computed flow profile may then serve as the flow rate characteristic used to further compute the average flow rate by multiplying the average velocity across the profile by the internal cross sectional area of the meter. Further, any pulse output from the meter must be subsequently generated based on the computed flow rate. Accordingly, the pulses generated by the meter may be delayed by at least the amount of time taken to compute the flow from the ultrasonic measurements and, additionally, may be delayed by the amount of time required to convert the computed flow rate to an output pulse train. In general, the total computational time delay may depend on the operational state of the flow computer and may vary from measurement to measurement. Thus, the total number of pulses counted during a proving run (i.e., between tₛₜₐᵣₜ and tₛₜₒₚ) may not accurately represent the precisely calibrated volume of fluid that passed through the meter during the proving run, but rather, may represent fluid that passed through the meter at some unknown time before the sphere detects.

Presently, UFMs are calibrated in a manner similar to that described above for turbine meters, i.e., by assuming the computational time delay is zero, or negligible. Such a method may work well when large volume provers are used because the computational time delay is a small fraction of the total proving time. However, for the case of SVPs, the computational time delay is not a negligible fraction (on the order of a percent or more) of the total proving time and accordingly, the calibration of UFMs using SVPs may not fall within American Petroleum Institute (API) or International Organization of Legal Metrology (OIML) requirements.

FIG. 2B shows an example of a possible computational time delay and its implications. If one assumes that the number of pulses between tₛₜₐᵣₜ and tₛₜₒₚ represents the actual volume of fluid that passed through the meter during the same time period then an erroneous result is obtained for the K-factor (i.e., slightly more than 5.5 pulses per prover volume). However, because of the computational time delays t_{delay1} and t_{delay2}, the actual pulses that should have been counted (i.e., the pulse that truly represent the actual fluid that flowed through the meter between tₛₜₐᵣₜ and tₛₜₒₚ) occur between t′ₛₜₐᵣₜ and t′ₛₜₒₚ (i.e., slightly more than 5.25 pulses per prover volume). In this example, ignoring the computational time delays leads to an overestimate of the number of pulses, and, thus, an error in the K-factor of about 5%. Furthermore, because t_{delay1} and t_{delay2} depend on the state of the external flow computer and, thus, may vary from run to run, the calibration may vary from run to run.

FIG. 3 shows an example of the typical repeatability of present day UFMs measured over the course of 20 proving runs using an SVP. The repeatability is quantified as ((High Counts−Low Counts)/Low Counts)×100. The solid line indicates the repeatability necessary (0.22%) to achieve the API specification for meter uncertainty of 0.027%.

Accordingly, there exists a need for a flow meter system and calibration method that allows for accurate calibration for any type of flow meter, regardless of the computational time delay.

### SUMMARY

In one aspect, one or more embodiments of the present disclosure relate to a method to calibrate a flow meter. The method includes passing a predetermined volume of fluid through a flow meter for calibration and determining a time duration of calibration from a start time to a stop time. One or more characteristics of the flow rate of the fluid is measured with the flow meter during the time duration and a plurality of time stamped measurements based on the one or more measured flow rate characteristics are generated. The flow meter is then calibrated based on the start time, the stop time, and the plurality of time stamped measurements.

In another aspect, one or more embodiments of the present disclosure relate to a calibration system. The system includes a prover configured to pass a predetermined volume of fluid through a flow meter, the flow meter configured to measure one or more characteristics of a flow rate for a time duration from a start time to a stop time. A signal processing unit is configured to generate a plurality of time stamped measurements based upon the one or more measured flow rate characteristics and configured to calibrate the flow meter based on the start time, the stop time, and the plurality of time stamped measurements.

Other aspects and advantages of the invention will be apparent from the following description and the appended claims.

### BRIEF DESCRIPTION OF DRAWINGS

FIGS. 1A-1C are schematics of a flow meter calibration system.

FIGS. 2A-2B illustrate one example of the output pulses and time delays associated with calibration of flow meters.

FIG. 3 shows an example of the repeatability of present day ultra sonic flow meters.

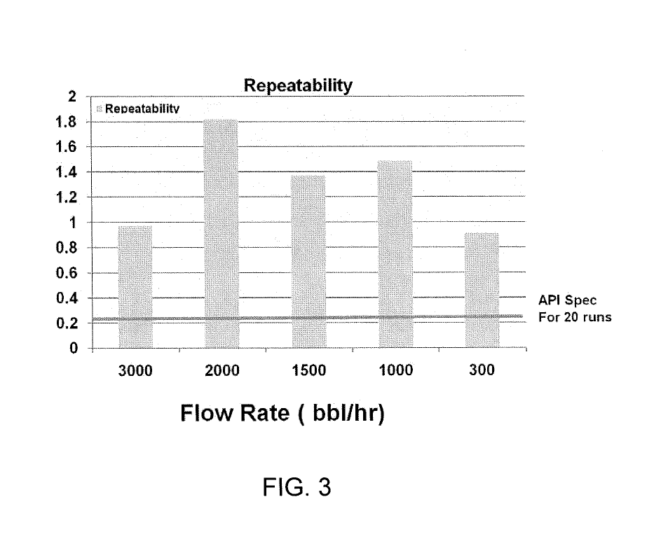

FIG. 4 is a schematic diagram in accordance with one or more embodiments of the present disclosure.

FIG. 5 is a series of timelines (Graphs A-E) in accordance with one or more embodiments of the present disclosure.

FIG. 6 is a flow chart showing an example of a calibration method in accordance with one or more embodiments of the present disclosure.

FIG. 7 shows a simplified timing diagram in accordance with one or more embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In accordance with one or more embodiments described herein, reliable methods and systems for accurately calibrating a UFM when using an SVP are presented. Further, one or more embodiments described herein provide methods and systems that account for the computational time delay and correct for any errors that result from the computational time delay in a calibration process for a UFM.

Further, in accordance with one or more embodiments, a UFM system is described that may be calibrated directly based on calculated flow rates and, thus, does not require the output of a secondary set of pulses for calibration.

As described above, UFMs require some amount of computational processing to determine the flow rate from a raw measured quantity. For the case of transit time UFMs, the raw transit time measurements must be processed in order to determine the flow rate. For example, in multipath systems, the transit times may first be processed to determine a flow profile. The flow profile itself may then be further processed to determine the measured flow rate. In traditional systems, the aforementioned processing steps cause an unknown computational time delay in the measurement-to-output time.

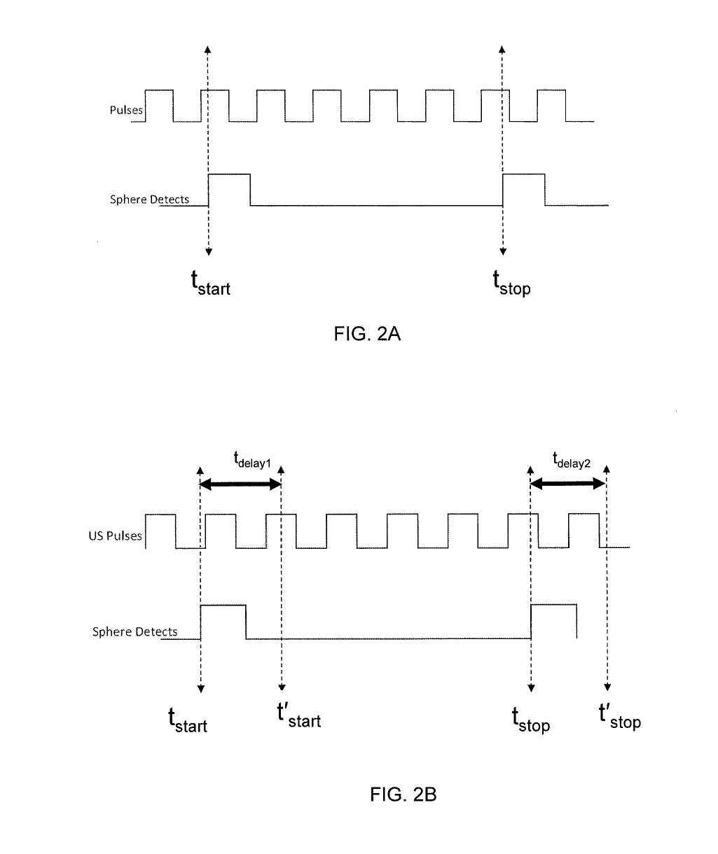

As described above, the calibration process historically used with respect to turbine flow meters is not suitable for UFMs. For calibrations made using an SVP, the inherent computational time delay of the UFM may encompass a non-negligible fraction of the total proving time tₛₜₐᵣₜ−tₛₜₒₚ, thus, resulting in unacceptable calibration errors. See the discussion in reference to FIG. 2A-2B above for more details regarding the limitations of existing calibration methods with respect to UFMs.

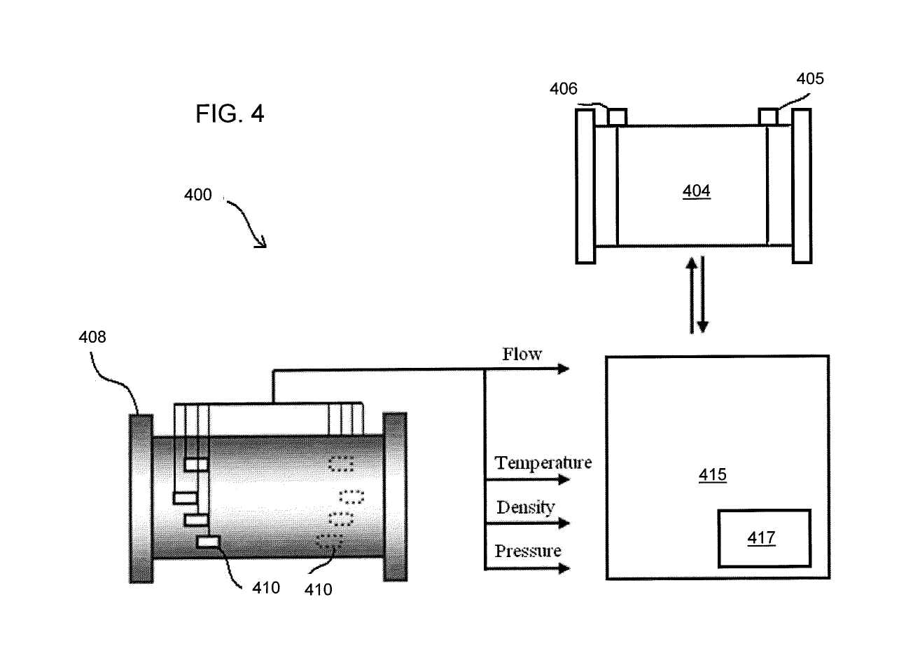

Referring initially to FIG. 4, a calibration system 400 in accordance with one or more embodiments will be described. The calibration system 400 includes an SVP 404, UFM 408, and signal processing unit (SPU) 415. The UFM 408 may include a plurality of ultrasonic sensors 410. The ultrasonic sensors 410 may be both transmitters and receivers of ultrasonic signals such that a signal may be sent from one sensor 410 to another sensor 410 to make measurements. Furthermore, ultrasonic sensors 410 may include any type of ultrasonic transducers known in the art.

UFM 408 may be similar to any UFM known in the art. Further, UFM 408 may be integrated onto a pipe or may be of a clamp-on type. For example, UFM 408 may be any of the type manufactured by Thermo Scientific, Waltham, Mass., and marketed as the DCT6088 Digital Correlation Transit Time Flowmeter, the M-PULSe Multi-Path Ultrasonic Flow Measurement System, the Sarasota 200/2000 Clamp On Flow Meters, or the SX30/40 Dual Frequency Doppler Flowmeters.

As is known in the art, UFM 408 may also be configured to include instrumentation capable of measuring the temperature, density, and pressure of the fluid passing through the UFM 408. Accordingly, the UFM 408 may be configured to make multiple measurements, of various types, with respect to fluid passing through the UFM 408.

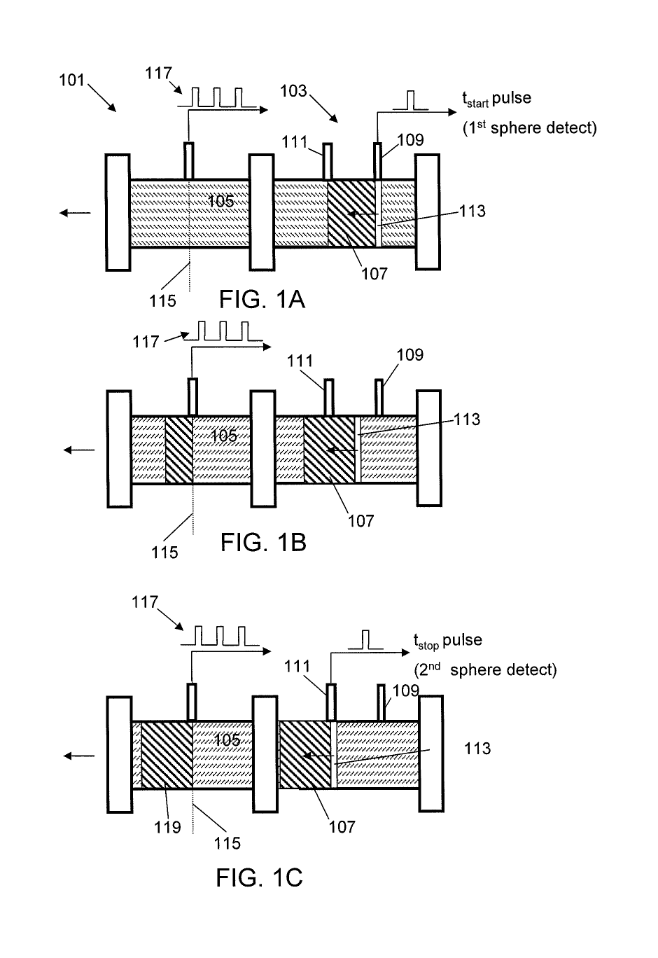

The SVP 404 may be fluidly connected to the UFM 408 by any means known in the art. The fluid connection between the SVP 404 and the UFM 408 allows for a precisely calibrated volume of fluid to be passed through the UFM 408 as described in detail above with reference to FIGS. 1A-C.

In certain embodiments, the SVP 404 may be configured with detectors 405 and 406 that detect the precise instant in time when an internal displacer, for example, a prover piston, ball, or the like, passes the location of detector 405 or 406, thereby indicating precisely the duration of time when the predetermined volume of fluid is forced through the UFM 408. The predetermined volume of fluid represents a precisely calibrated volume of fluid that corresponds to the volume SVP's internal bore cylinder, as described above in relation to FIGS. 1A-C. As used herein, the term sphere detects may alternatively be used for the indications made by detectors 405 and 406, regardless of the type of internal displacer. When the detector 405 is triggered (at tₛₜₐᵣₜ) the proving run begins, and when detector 406 is triggered (at tₛₜₒₚ) the proving run ends. Thus, the detector 405 signals when the precisely calibrated volume of fluid being passing through the meter under calibration and the detector 406 signals when the precisely calibrated volume of fluid has finished passing through the meter under calibration.

The SPU 415 is further configured to receive and transmit data from the UFM 408 and to receive and transmit data from the SVP 404. Furthermore, the SPU 415 includes a built-in flow computer 417 configured to time stamp various events based on a single master clock or CPU included within the built-in flow computer. For example, the built-in flow computer may record the time when trigger pulses from detectors 405 and 406 occur, the time when the individual transducers housed within sensors 410 are fired (i.e., when measurement are made), the time that individual flow computations are completed, the time calibration pulses are generated/output from the flow computer 417, etc. Further, time stamped fluid flow measurements, such as velocity, temperature, density, and pressure may be sent from the UFM 408 to the SPU 415, along with any internal time stamps applied to and/or made with the measurements. Accordingly, the SPU 415 records and processes the time stamp for each event, allowing precise measurement of the time that detectors 405 and 406 are triggered and the time each measurement is made by the UFM 408.

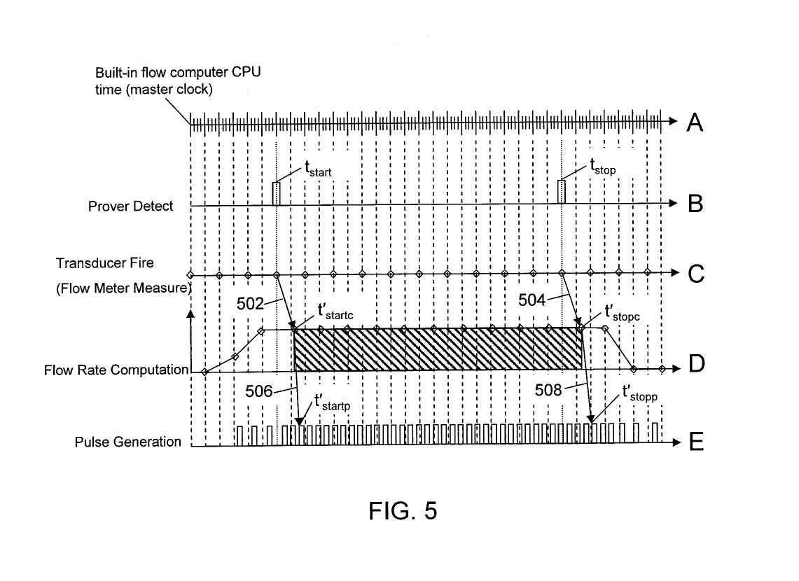

Through the knowledge of the precise start time and stop time of the passing of the predetermined volume of fluid through the UFM 408 and the precise time that transducer measurements are made, the UFM 408 may be precisely and reliably calibrated. In accordance with one or more embodiments, a single clock, timer, or oscillator, within the built-in flow computer is used to accurately timestamp all of the relevant events during the calibration process. The use of a single clock (i.e., a master clock), timer, or oscillator allows for the built-in flow computer to precisely measure and account for any computational time delays that occur in the system during calibration, as described in further detail below with reference to FIG. 5.

In addition to the built-in flow computer and internal clock, timer, or oscillator, the SPU 415 may include electronics and employ capabilities typical of flow computers known in the art. The SPU 415 may include a computer, programmable logic controller, or other electronic calculation device known in the art. The SPU 415 may have a processor and operable memory. The processor and operable memory may be used to carry out time stamping of events and to carry out calculations, conversions, and other computations for the calibration process. The operable memory may be configured to store a calibration program and may further be configured to store event information associated with the calibration process, such as the time stamps, measurement data, and other information and/or data associated with the calibration process. The processor may be configured to run software or other computer programs for and/or during the calibration process.

Moreover, as noted above, the SPU 415 may be separate from the UFM 408. However, those skilled in the art will appreciate that the SPU 415 may be integrated with the UFM 408 or be integrated with other equipment. As described above, the SPU 415 may be configured to calculate a measured volume of fluid that passes through the UFM 408 using the flow data sent from the UFM 408 to the SPU 415.

The calibration of the UFM 408 is made by determining a calibration factor, or meter factor. To determine the meter factor, the measured volume, as measured by the flow meter 408, is compared to predetermined, known volume of the SVP 404. In accordance with one or more embodiments, the measured volume may be determined either by counting output pulses or by integrating the computed flow rates directly, as described below.

Now with reference to FIG. 5, the process of correlating the measurement times will be described in accordance with one or more embodiments of the present disclosure. FIG. 5 shows five timelines A, B, C, D, and E. Master clock timeline A is the time as measured by a flow computer that is built-in to the SPU and serves as the master clock or timer from which all timestamps will originate. Accordingly, the vertical dashed lines represent the master time that is used to time stamp all relevant events during the calibration process. Prover timeline B shows a timeline indicating when the prover sphere detects occur. As measured by the master clock, the sphere detects occur and are time stamped at time tₛₜₐᵣₜ when the first detector of the SVP is triggered by the internal displacer and at time tₛₜₒₚ when the second detector of the SVP is triggered by the internal displacer, indicating the beginning/start and end/stop of the proving run, respectively.

Transducer timeline C is a timeline showing the sequence of time stamped measurements of the fluid flow made by the UFM. For example, the open diamonds represent time stamped measurements associated, for example, with the time stamped firing of UFM transducers. One of ordinary skill will appreciate that a UFM may employ multiple transducers that may be fired separately or in combination in order to make a flow rate measurement. Accordingly, the master timer may be used to timestamp all or a subset of the measurements for use in the calibration process. For simplicity, the open diamonds shown on timeline C may be understood to represent the time that individual UFM transducers were fired to conduct, for example, a transit time type flow measurement.

Calculation timeline D shows a timeline of calculations made by the signal processing unit. As can be seen in FIG. 5, these calculations are delayed relative to the measurements by some amount representative of the computational delay described above. This computational time delay may be a result of the computational processing time needed to convert the raw measurement into a unit or value that may be appropriately used to determine the fluid volume and/or flow rate. In accordance with one or more embodiments of the present disclosure each individual calculation may be time stamped using the master clock as shown by the open diamonds on timeline D. Furthermore, the ordinate of timeline D indicates examples of the calculated flow rate values from each measurement.

Finally, timeline E shows a plot of generated pulses as a function of time as measured by the master clock. Each pulse may be time stamped in order to keep track of the additional time delay that results from any pulse generation and output circuitry.

In accordance with one or more embodiments of the present disclosure, the time stamping of both the UFM transducer firings and the sphere detects by the same master clock allows for the unambiguous identification by the built-in flow computer of which flow rate computations originated from measurements that were initiated at or near tₛₜₐᵣₜ and tₛₜₒₚ. Timeline D shows that measurements that occurred synchronously or nearly synchronously with the sphere detects at tₛₜₐᵣₜ and tₛₜₒₚ resulted in flow calculations that occurred a short time later at t′ₛₜₐᵣₜ and t′ₛₜₒₚ, due to computational delays. Thus, the volume measured by the UFM between tₛₜₐᵣₜ and tₛₜₒₚ may be obtained by integrating the measured flow rate from t′ₛₜₐᵣₜ and t′ₛₜₒₚ. The measured volume is represented by the area of the filled rectangle shown in timeline D. Since the actual volume passed through the UFM is defined by the prover volume, the measured volume may be compared to the actual volume and a calibration factor may be derived. For example, the calibration factor may be the ratio of the UFM measured volume to the prover volume.

The time correlation lines 502 and 504 represent the correlation of the measurements (i.e., transducer fires) to the flow rate value computations. Because each instance of measurement and computation is time stamped, the points of computation, in relation to the time of measurement may be precisely known and correlated. As such, correlation lines 502 and 504, between Graph C and Graph D, represent the correction for any time delay, and an accurate measurement of the volume passed through the UFM may be determined. Similarly, if the UFM is configured to generate output pulses that depend on the computed flow rate values (e.g., to interface more easily with existing systems that employ turbine meters), each instance of pulse generation may be time stamped as illustrated in timeline E. Accordingly, correlation lines 506 and 508, between Graph D and Graph E, represent the correction for any time delay, and an accurate measurement of the volume passed through the UFM may be determined.

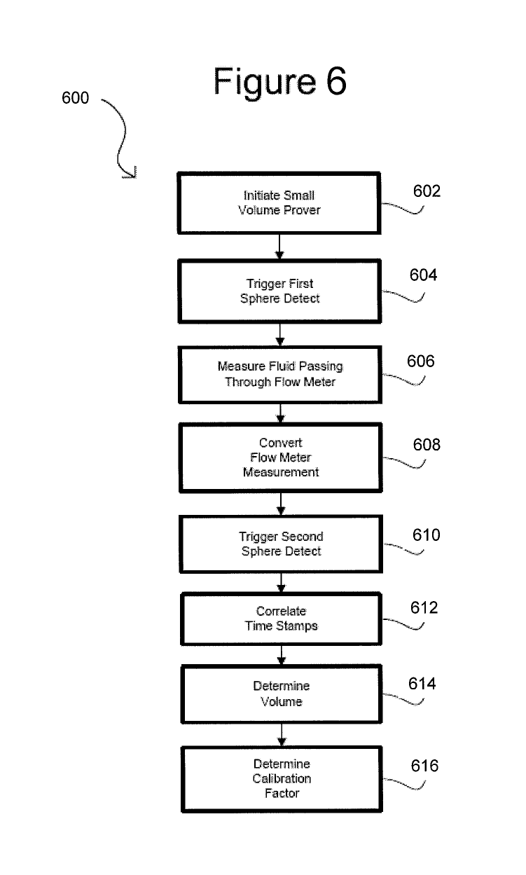

Now referring to FIG. 6, a process 600 of calibrating a UFM using an SVP is shown. In this process, an SVP is fluidly connected to a UFM and the prover is configured to pass fluid from the prover through the UFM. Further, an SPU is electrically connected to both the SVP and the UFM.

At initial step 602 a calibration process starts by initiating the SVP to pass fluid through the UFM. In particular, the volume between two points within the prover may be precisely known. For example, a first and a second detector, or other trigger device, may be configured with the prover such that the fluid volume present between the first and the second detectors is precisely known.

Next, at step 604, the SVP may initiate a volume calculation/measurement for calibration by triggering the first detector or other first trigger device. The triggered detector in step 604 may be configured to fire at the instant when the SVP displacer or sphere passes the detector. Accordingly, step 604 may occur slightly after fluid begins to flow from the prover, as the SVP may need to increase flow rate to a predetermined minimum flow rate. Additionally, at step 604, the SVP or a connected SPU may time stamp the firing of the first detector, thereby recording the instant of the start of the calibration of the UFM. The time stamp of the first sphere detect may be stored in an SPU or other storage device.

Next, at step 606, the UFM may measure the fluid passing through the UFM. Each measurement may be time stamped by the same timer or one synchronized with the timer that is used to time stamp the first sphere detect during step 604. When using a UFM, a measurement includes a firing of an ultrasonic transducer. Accordingly, each firing of an ultrasonic transducer is time stamped. Although described herein with the measuring of the fluid flow occurring after the start of the prover, those skilled in the art will appreciate that the measuring of the fluid by the UFM may be continuous throughout the process, for example, starting before the prover begins to pass fluid from the prover through the UFM. The time stamped measurements made by the UFM may be stored in the SPU or other storage device.

At step 608, flow rates are computed from the time stamped UFM measurements. For example, the transit time measured by a UFM may be converted into a flow rate. At step 608, each instance of computation may also be time stamped. The time stamped computations based on the time stamped measurements may be stored in the SPU or other storage device.

At step 610, the SVP may trigger a second sphere detect, signaling the end of the calibration fluid passing through the UFM. This second sphere detect may be time stamped as well. Accordingly, the instant of the end of the calibration may be precisely known. The time stamp of the second sphere detect may be stored in an SPU or other storage device.

At step 612, the SPU may correlate the time stamps of the calibration process. In particular, the timings of the start time (first sphere detect), stop time (second sphere detect), each measurement, and each calculation, may be correlated based on the time stamps from the master timer/clock located with the SPU. One of ordinary skill will appreciate that multiple clocks at multiple locations may be used if all clocks are synchronized with the master clock (i.e., master-slave configuration) without departing from the scope of the present disclosure.

At step 614, the SPU may determine a volume of fluid measured to pass through the UFM. As noted above, alternatively, the UFM may make this calculation. This determination may be made by using the time stamped computed flow rates, time stamped measurements, and the time duration of the calibration, as determined from the sphere detect time stamps.

At step 616, using the correlated time stamped measurements, the predetermined volume from the SVP may be compared against the measured volume as measured by the UFM or signal processing unit. From the comparison, a calibration factor may be calculated and the flow meter may be appropriately calibrated.

Although process 600 is described herein with specific steps occurring in particular order, those skilled in the art will appreciate that certain steps may occur in an alternative order, or simultaneously with each other, without departing from the scope of the present disclosure.

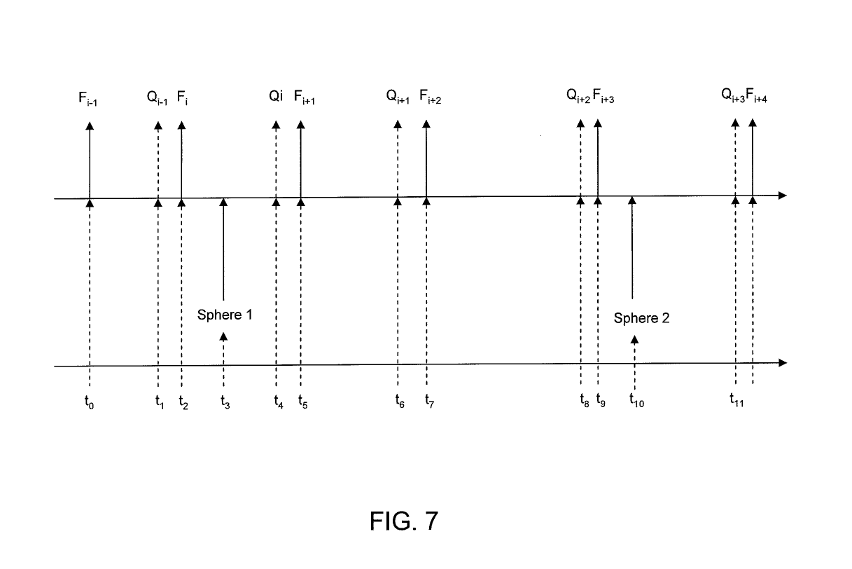

FIG. 7 shows an example of a simplified timing diagram for accurately calibrating a UFM when using an SVP in accordance with one or more embodiments. One of ordinary skill will appreciate that an actual proving run in the field may involve many more timestamps and transducer fires that shown in the simplified diagram. The label Fᵢ is used to denote the firing of an ultrasonic transducer and the variable Qᵢ is used to denote the computed flow rate that is based on the data collected from the transducer fire Fᵢ. The table below summarizes the variable definitions used for FIG. 7.

| Label | Meaning | Time |
|---|---|---|
| Fᵢ₋₁ | FIRE previous to FIRE just before Detector 1 seen | t₀ |
| Qᵢ₋₁ | Flow Rate for FIRE previous to FIRE just before Detector 1 | t₁ |
| | seen | |
| Fᵢ | FIRE before SVP Detector #1 seen | t₂ |
| Det1 | Detector #1 seen from SVP (first sphere detect) | t₃ |
| Qᵢ | Flow Rate for Fire for Fire pulse at Time Fᵢ | t₄ |
| Fᵢ₊₁ | Fire During prove at time T2 | t₅ |
| Qᵢ₊₁ | Flow Calculated for Fire during prove | t₆ |
| Fᵢ₊₂ | Fire During prove just before we see Detector #1 | t₇ |
| Qᵢ₊₂ | Flow Calculated for Fire just before Detector #2 seen | t₈ |
| Fᵢ₊₃ | Fire just before Detector #2 seen | t₉ |
| Det2 | Detector #2 seen from SVP (second sphere detect) | t₁₀ |
| Qᵢ₊₁ | Flow Rate for Fire just before Detector #2 seen | t₁₁ |

As described above, in reference to FIG. 5, for any given transducer fire Fᵢ, the flow rate Qᵢ is output a short time later due to computational time delays. The time delay can negatively affect the calibration accuracy for small volume provers (SVP's). By time stamping when the transducers fire and when the sphere detects occur, the computational time delay may be accounted for and the calibration accuracy may be improved. More specifically, an improved determination of flow rates calculated during the proving run may be obtained and these flow rates may then be correlated to the actual times that the detectors from the SVP fire (the sphere detects).

In accordance with one or more embodiments, the same timer is used for time stamping exactly when the transducers are fired and the time when the sphere detects occur As described above, the sphere detects signal the beginning and end of the prove. A simplified example is described below.

For the first sphere detect we use the time period t₃ to t₅ and apply the flow rate Qᵢ. For the second sphere detect we use the time period t₉ to t₁₀ and apply the flow rate Qᵢ₊₃. Accordingly, the total volume between sphere detects may be calculated as follows:

V_{PROVE}=Qᵢ×(t₅−t₃)+Qᵢ₊₁×(t₇−t₅)+Qᵢ₊₂×(t₉−t₇)+Qᵢ₊₃×(t₁₀−t₉)

One of ordinary skill will appreciate that the above is a simplified example and that in any real-world application of the present disclosure, very may more transducer fires and flow calculations may occur. Nevertheless, because V_{PROVE} volume is internally calculated using the built-in flow computer, the volume that passed through the SVP is more accurately determined because there is no need to count or interpolate pulses generated via a user entered K-Factor.

In accordance with one or more alternative embodiments, a flow computer may be configured to be integrated with a UFM thereby reducing or eliminating time delay errors associated with the measurement-calculation time. Further, an internal flow computer may not require a measurement-calculation time delay because the total volume can be calculated internally within the UFM itself. Moreover, any measurements and calculations can be configured to use the same processor and timers, allowing for correlation and accuracy associated with the measurements. Additionally, the firing of ultrasonic sensors of the UFM can be time stamped, allowing accurate tracking and correlation of collected and processed data for calibration.

Accordingly, embodiments of the present disclosure allow for a precise calibration of a flow meter. For example, a UFM may be precisely calibrated even when using an SVP.

Advantageously, a time correction is made possible, wherein the time delay for calculation of appropriate values may be corrected for and properly correlated with when the associated measurements are made.

Although described herein applied to an SVP and a UFM, those skilled in the art will appreciate that any other prover and/or flow meter may employ the methods and processes described herein without departing from the scope of the disclosure.

Advantageously, embodiments disclosed here provide an inbuilt flow computer in the signal processing unit of a UFM. The system may take flow, pressure, temperature, and density inputs from the UFM and an attached prover to internally calculate a corrected flow in compliance with API and OIML requirements and standards.

Advantageously, one or more embodiments disclosed herein are configured to reduce repeatability errors during calibration against an SVP when using a UFM. This may be accomplished by time stamping all events on the same computer/processor thus preventing delays and errors. Moreover, one or more embodiments described herein may reduce repeatability errors during calibration against any prover, such as a ball prover or piston prover, by time stamping all events on the same computer/processor thus preventing delays and errors.

Advantageously, because a UFM may be used with embodiments described herein, calculation delays may be reduced by eliminating the need to produce external pulses based on the calculated volume using a transit time method.

Advantageously, one or more embodiments described herein may be used with any type of UFM. For example, the inbuilt flow computer employed with clamp on (single path and multiple path), insertion type (single path and multiple path), embedded type (single path and multiple path), and any other types of UFMs. Moreover, all frequencies of UFMs, and the transducers therein, may be used with embodiments disclosed herein. For example, 250 kHz, 500 kHz, and 1000 kHz transducers may be used without affecting the accuracy of the calculations and time correction/correlation.

Advantageously, any form of fluid may be used, and as such, UFMs for gases and/or liquids may be calibrated with one or more embodiments described herein. Moreover, the integrated processor or SPU may be positioned either on top of the meter in the Zone 1/Class I area or in a remote location in the Zone 1/Class I area or in a remote location in a Zone 2/Class 2 Area, without departing from the scope of the claims. Furthermore, embodiments described herein may be used for both uni-directional and bi-directional measurements and calibrations.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A method to calibrate a flow meter, the method comprising:
passing a predetermined volume of fluid through the flow meter for calibration;
determining a time duration of calibration from a start time to a stop time;
measuring one or more characteristics of the flow rate of the fluid with the flow meter during the time duration;
generating a plurality of time stamped measurements based on the one or more measured flow rate characteristics; and
determining a calibration factor based on the start time, the stop time, and the plurality of time stamped measurements.

2. The method of claim 1, further comprising:
calculating a plurality of flow rate values from the plurality of time stamped measurements; and
correlating the plurality of flow rate values with the determined start time and stop time.

3. The method of claim 1, wherein the calibrating comprises:
determining a measured volume of fluid passing through the flow meter during the time duration; and
determining the calibration factor based on the measured volume and the predetermined volume.

4. The method of claim 3, wherein the determining of the measured volume comprises:
calculating a volume of fluid based on the generated plurality of time stamped measurements of the flow rate.

5. The method of claim 1, wherein the determined start time, the determined stop time, and the determined plurality of time stamped measurements are time stamped by a single processor.

6. The method of claim 1, further comprising:
measuring a pressure, a temperature, and a density of the fluid passed through the flow meter.

7. The method of claim 1, wherein a small volume prover (SVP) is used to pass the fluid through the flow meter.

8. The method of claim 1, wherein the measuring the flow rate comprises:
using an ultrasonic meter to measure the flow rate.

9. The method of claim 1, wherein the flow rate characteristic comprises a velocity of the fluid flow.

10. A calibration system, the system comprising:
a prover configured to pass a predetermined volume of fluid through a flow meter, the flow meter configured to measure one or more characteristics of a flow rate for a time duration from a start time to a stop time;
a signal processing unit configured to generate a plurality of time stamped measurements based upon the one or more measured flow rate characteristics and configured to determine a calibration factor based on the start time, the stop time, and the plurality of time stamped measurements.

11. The system of claim 10, wherein the signal processing unit comprises:
a processor; and
an operable memory connected to the processor.

12. The system of claim 10, wherein the signal processing unit is configured to determine temperature, pressure, and density of the fluid passed through the flow meter.

13. The system of claim 10, wherein the flow meter comprises an ultra-sonic flow meter (UFM).

14. The system of claim 13, wherein the UFM operates at one of 250 kHz, 500 kHz and 1000 kHz.

15. The system of claim 10, wherein the prover is an SVP.

16. The system of claim 10, wherein the signal processing unit is configured to calculate a plurality of flow rate values from the plurality of flow rate characteristic measurements and to correlate the plurality of flow rate values with the start time and the stop time.

17. The system of claim 10, wherein the signal processing unit is configured to calculate a measured volume of fluid passing through the flow meter during the time duration and configured to determine a calibration factor based on the measured volume and the predetermined volume.

18. The system of claim 10, wherein the measured volume is based on the generated plurality of time stamped measurements of the flow rate.

19. The system of claim 10, wherein the prover is one of a ball prover and a piston prover.

20. A computer readable storage medium storing instructions for calibrating a flow meter, the instructions comprising functionality to:
determine a time duration of calibration from a start time to a stop time of a predetermined volume of fluid passing through a flow meter;
generate a plurality of time stamped measurements based on one or more measured flow rate characteristics measured by the flow meter; and
determine a calibration factor based on the start time, the stop time, and the plurality of time stamped measurements.
